(19) United States
(12) Patent Application Publication
(10) Pub. No.: US 2007/0180390 A1
(43) Pub. Date: Aug. 2, 2007

(54) Enhanced information display system and method

(75) Inventors: Yan Lin Aung, Peoria, AZ (US); Philip M. Htoon, Scottsdale, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/649,093

(22) Filed: Jan. 3, 2007

Related U.S. Application Data
(63) Continuation-in-part of application No. 11/344,744, filed on Jan. 31, 2006.

(51) Int. Cl. G06F 3/048

(52) U.S. Cl. 715/764

(57) ABSTRACT

A display device includes a display region that is divided into at least a selected-page information display area and an enhanced information display area. The selected-page information display area is used to display a display page selected from a set of selectable display pages. The enhanced information display area is used to selectively display information that is not displayed in the selected-page information display area.

### CROSS-REFERENCE TO RELATED APPLICATIONS

This application is a continuation-in-part of application Ser. No. 11/344,744 filed Jan. 31, 2006.

### TECHNICAL FIELD

The present invention generally relates to a display device and, in particular, to a method and system for displaying enhanced information on a display device.

### BACKGROUND

Display devices are used to provide visual feedback to one or more users. For example, modern aircraft typically include one or more display devices that are used to display various types of information to the flight crew and/or aircraft maintenance personnel. The display devices typically have a display area in which the information is displayed. Often, the amount of information that may need to be displayed may not fit within the display area. As a result, the information may be divided between multiple display pages. Typically, each of the multiple display pages is configured to display specific information. One drawback to this approach is that a user may have to maneuver through one or more display pages to view specific information that is displayed on another display page. This can be especially burdensome if the user's attention needs to be focused on other tasks. For example, paging through multiple display pages may distract a pilot from other duties.

Accordingly, it is desirable to provide a method and system for displaying information on a display device without having to maneuver through one or more display pages that are not currently being displayed. Furthermore, other desirable features and characteristics of the present invention will become apparent from the subsequent detailed description of the invention and the appended claims, taken in conjunction with the accompanying drawings and the background of the invention.

### BRIEF SUMMARY

In one embodiment, and by way of example only, a display system includes a display device and a display processor. The display device has a display region divided into a plurality of display areas. The display areas include at least a selected-page information display area and an enhanced information display area. The display processor is coupled to the display device and is operable to supply display commands thereto that cause the display device to display one of a plurality of selectable display pages in the selected-page information display area and selectively display information in the enhanced information display area. The information displayed in the enhanced information display area is not displayed in the display page being displayed in the selected-page information display area.

In another exemplary embodiment, a method of displaying enhanced information on a display device having at least a display region includes displaying a display page selected from a set of selectable display pages in a selected-page information display area in the display region. A determination is made as to whether the enhanced information is displayed in the display page currently being displayed in the selected-page information display area. The enhanced information is displayed in an enhanced information display area of the display region only if it is determined that the enhanced information is not displayed in the display page currently being displayed in the selected-page information display area.

### BRIEF DESCRIPTION OF THE DRAWINGS

The present invention will hereinafter be described in conjunction with the following drawing figures, wherein like numerals denote like elements, and:

FIG. 1 depicts a front view of an exemplary display device and portions of a display system in accordance with an embodiment of the present invention;

FIG. 2 depicts a front view of an exemplary display device according to an alternative embodiment;

FIGS. 3-9 depict front views of yet another exemplary display device according to yet another alternative embodiment with the display device in various configurations;

FIG. 10 is a functional block diagram of a display system that may be used to control the operation of the display device as depicted in FIGS. 3-9.

### DETAILED DESCRIPTION OF VARIOUS PREFERRED EMBODIMENTS

The following detailed description is merely exemplary in nature and is not intended to limit the invention or the application and uses of the invention. Furthermore, there is no intention to be bound by any theory presented in the preceding background or the following detailed description.

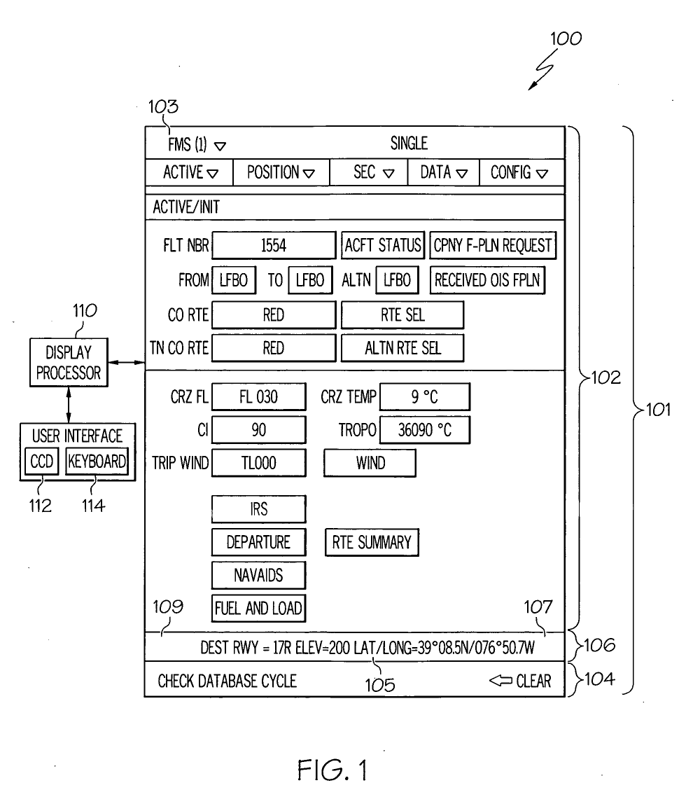

Referring now to FIG. 1, an exemplary display device 100 is depicted, and includes a display region 101 that is divided into multiple display areas. These display areas include a selected-page information display area 102, a scratch pad area 104, and an enhanced information display area 106. The display device 100 can be any one of numerous devices capable of displaying textual and/or graphical information such as, for example, a liquid crystal display, a cathode ray tube display, or an organic light emitting diode display, just to name a few. In one exemplary embodiment, the display device 100 is implemented as an avionics display device that is coupled to one or more display processors 110 that configure the display device 100 to display various avionics data and flight information such as, for example, the flight number, aircraft altitude, aircraft speed, and the like.

No matter the specific type of data and information that are displayed, the display device 100, in response to display commands from the display processor 110, displays the information in the selected-page information display area 102. In a typical embodiment, the selected-page information display area 102 is too small to display all of the data and information that a user may need to view on the display device 100. Thus, the information is divided amongst a number of display pages 103 that can be displayed one display page 103 at a time in the selected-page information display area 102. Typically, each display page 103 has associated therewith, and is used to display, specific types of information. A user can switch between display pages 103 using any one of numerous types of user interfaces. For example, a user may use a cursor control device 112, such as a mouse or trackball that is in operable communication with the display processor 110.

The scratch pad area 104 is used to display textual information entered by a user. For example, a pilot may need to enter various types of flight related information. Preferably, as the text is entered, the scratch pad area 104 displays the text, providing visual feedback to the pilot. It will be appreciated that the text may be entered using any one of numerous types of user interfaces such as, for example, a keyboard 114 that is in operable communication with the display processor 110. It will additionally be appreciated that in some embodiments the scratch pad area 104 may not be included.

As discussed previously, locating specific information associated with individual display pages 103 can be time consuming and distracting to user of the display 100. The enhanced information display area 106 is used to display information 105 that is not currently being displayed in the selected-page information display area 102. In one embodiment, the information 105 is displayed by scrolling textual, graphic, and/or iconic characters that comprise the information 105 across the enhanced information display area 106. The scrolling may, for example, begin at the right side 107 of the enhanced information display area 106, move to the left, and then disappear at the left side 109 of the enhanced information display area 106. The display processor 110 may command the same information 105 to be repeatedly displayed in the enhanced information display area 106, in this same scrolling manner, or command other information to begin scrolling across the enhanced information display area 106. It will be appreciated that scrolling the information across the enhanced information display area 106 from right to left is merely exemplary of one particular embodiment, and that the display processor 110 could also move the information 105 from left to right and/or could start the characters that comprise the information 105 at any one of numerous positions within the enhanced information display area 106.

Although the enhanced information display area 106 is depicted as being disposed near the bottom of display device 100, it could be disposed in any one of numerous positions. It will additionally be appreciated that the display device 100 could be configured such that the enhanced information display area 106 is vertically aligned, rather than horizontally aligned. If the enhanced information display area 106 is vertically aligned, the display processor 110 could command the information 105 to scroll from top to bottom or from bottom to top, as needed or desired. Moreover, scrolling the information 105 across the enhanced information display area 106 is also merely exemplary. In various alternative embodiments, the display processor 110 could command the information 105 be displayed in the enhanced information display area 106 by flashing the textual, graphic, or iconic data that make up the information 105, and then displaying a blank enhanced information display area 106. Repeatedly flashing the information 105 can draw the attention of a user to the display 100.

In addition to the above, it is noted that in the depicted embodiment, the enhanced information display area 106 supports one line of textual, graphic, and/or iconic characters. However, the enhanced information display area 106 could be configured to support multiple lines of characters. Moreover, the display processor 110 could be configured such that the color of the characters that comprise the information 105 may vary. For example, the display processor 110 could command the display device 100 to display information 105 representative of nominal conditions in the enhanced display area 106 using white characters, and to display information representative of off-nominal conditions using amber or red characters. It will be appreciated that various other character color coding schemes could also be used. In still another exemplary embodiment, the information 105 can be repeatedly displayed, by moving the message across the enhanced information display area 106. Alternatively, the length of time or number of times particular information 105 is displayed can be predetermined.

As was alluded to further above, the information 105 that is (or can be) displayed in the enhanced information display area 106 depends upon the information that is currently being displayed in the selected-page information display area 102. For example, if a display page 103 is selected such that the selected-page information display area 102 is currently displaying information related to the flight management system, information not currently displayed in the selected-page information display area 102 can be displayed in the enhanced information display area 106. The information 105 displayed in the enhanced information display area 106 may be information contained in a display page 103 that is not currently selected, or it can be any other information not displayed in any of the selectable display page 103, such as alert messages and the like. By displaying information from non-displayed display pages 103, the amount of time a user may spend manipulating the display pages 103 can be reduced. Additionally, displaying information that does not appear on any of the display pages 103 allows additional information to be provided to the user that might not otherwise be readily displayed.

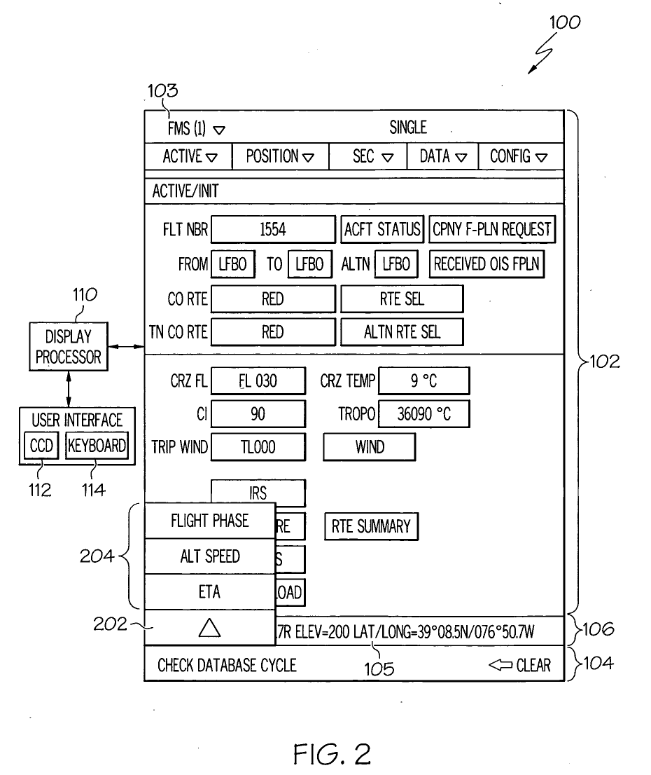

Referring to FIG. 2, yet another alternative exemplary embodiment of the display 100 is depicted and will now be briefly described. In this embodiment, instead of moving information 105 across the enhanced information display area 106, a selection icon 202 is displayed that, when selected, shows a number of identifiers 204. These identifiers 204, which may vary, identify the types of information 105 that may be displayed in the enhanced information display area 106. Preferably, a user selects one of the identifiers 204 using, for example, any one of the previously identified user interfaces 112, 114. In response, the display processor 110 causes the information 105 related to the selected identifier 204 to be displayed in the enhanced information display area 106. It will be appreciated that the information 105 may be displayed in the enhanced information display area 106 in accordance with any one of the previously described display schemes.

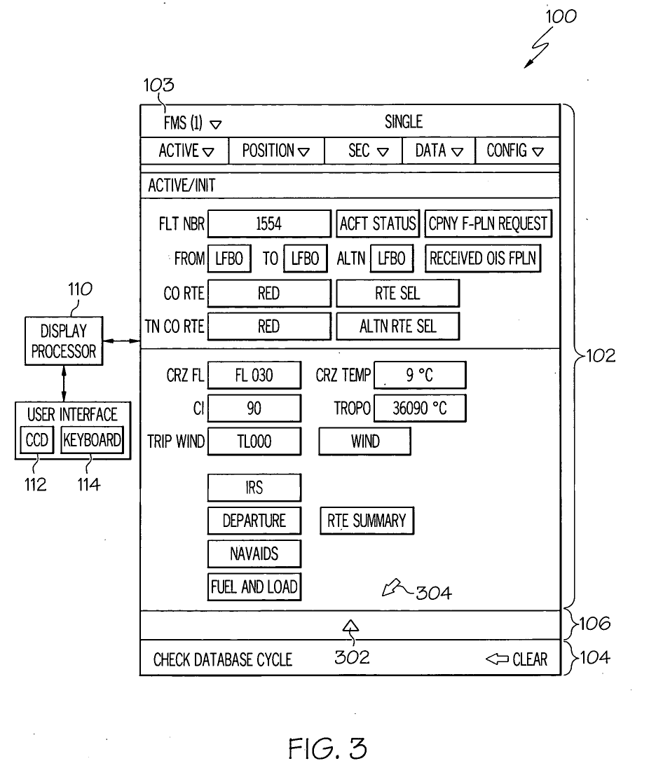

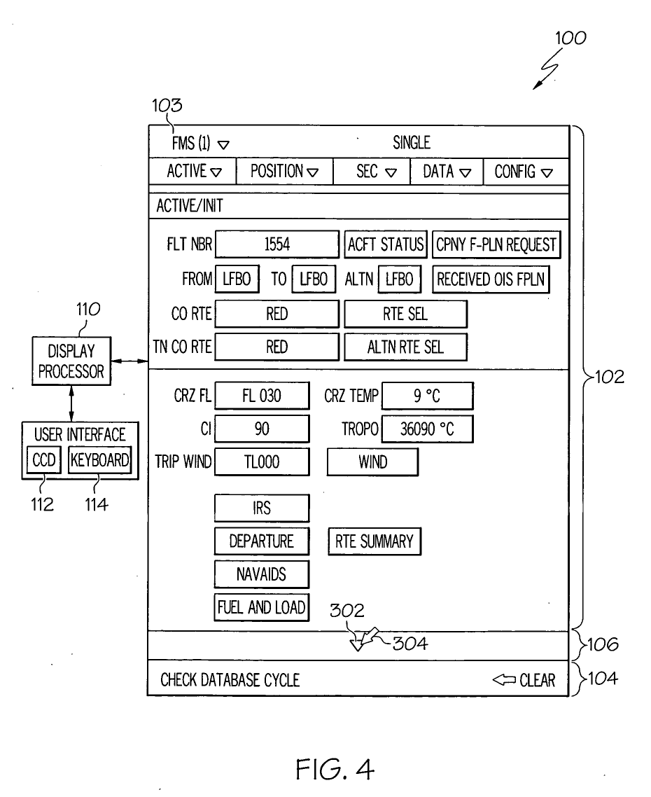

Turning now to FIG. 3, yet another alternative embodiment of the display device 100 will be described. In this alternative embodiment, information 105 is selectively displayed in the enhanced information display area 106. More specifically, at least in the depicted embodiment, a selection icon 302 is displayed that, when selected, causes information 105 to be displayed in the enhanced information display area 106. Preferably, the selection icon 302 is selected by moving a cursor 304 over the selection icon 302, and then providing some type of user input via one of the user interfaces 112, 114. For example, and as shown in FIG. 4, a user may use the cursor control device 112 to move the cursor 304 over the selection icon 302, and then select the selection icon 302 by pressing a button or other user input device 402 on the cursor control device 112.

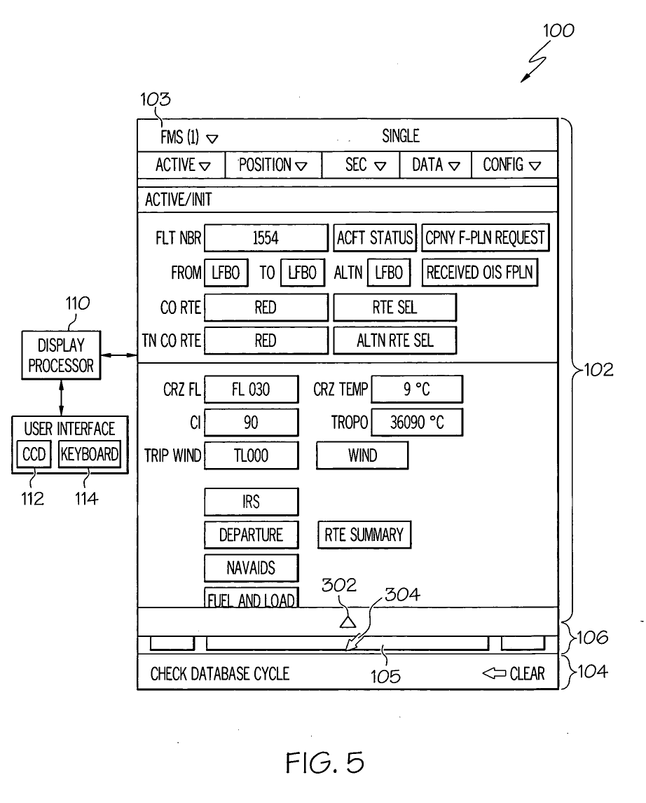

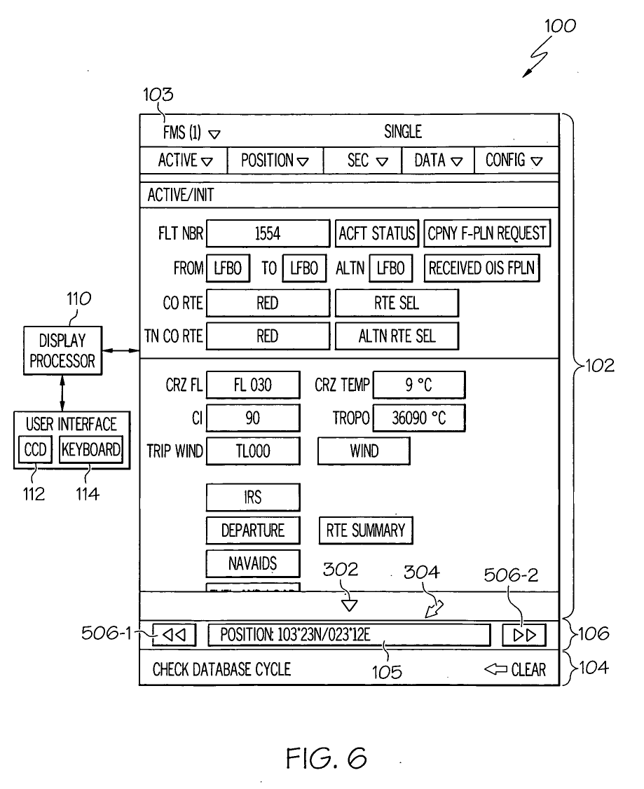

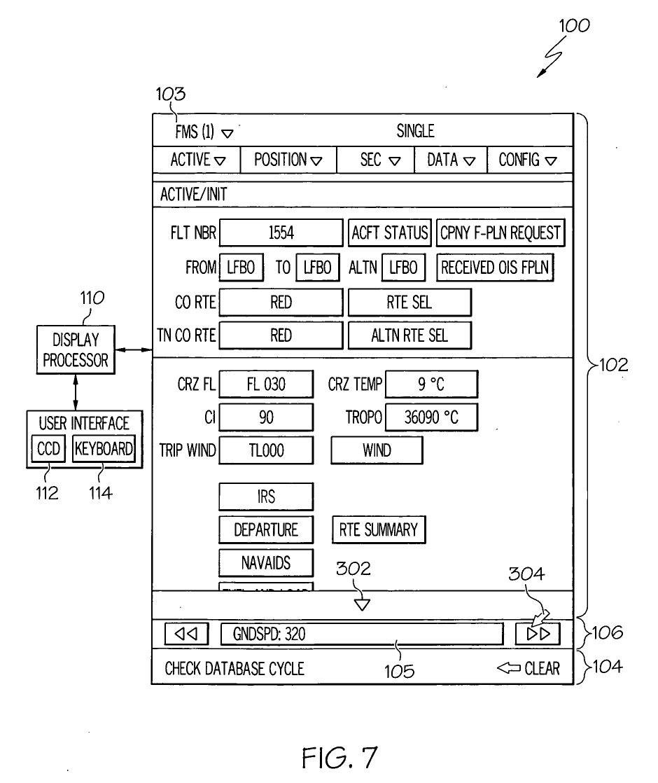

When the selection icon 302 is selected, the display processor 110 commands the display device 100 to display information 105 in the enhanced information display area 106. Although this may be implemented in accordance with any one of numerous techniques, in the depicted embodiment, and as shown in FIGS. 5 and 6, this is implemented by the display processor 110 commanding the display device 110 to gradually display the enhanced information display area 106 and the information 105 in the enhanced information display area 106. As FIG. 6 further depicts, the display processor 110, upon selection of the selection icon 302, also preferably commands the display device 100 to display information scroll icons 506 (e.g., 506-1, 506-2) in the enhanced information display area 106. The information scroll icons 506 are used to scroll through a plurality of different types or categories of information 105. For example, in FIG. 6 the information 105 that is displayed in the enhanced information display area 106 is aircraft position information. However, as depicted in FIG. 7, if a user selects either of the information scroll icons 506 using, for example, the cursor control device 112, the display processor 110 commands the display device 100 to display different information 105, such as aircraft ground speed information, in the enhanced information display area 106.

Before proceeding further it is noted that, similar to the previously described embodiments, the information 105 that is (or can be) displayed in the enhanced information display area 106 may depend upon the information that is currently being displayed in the selected-page information display area 102. More specifically, the information 105 that may be displayed in the enhanced information display area 106 is information contained in a display page 103 that is not currently selected, or is any one of numerous other types of information that is not displayed on any of the selectable display pages 103, such as alerts and the like.

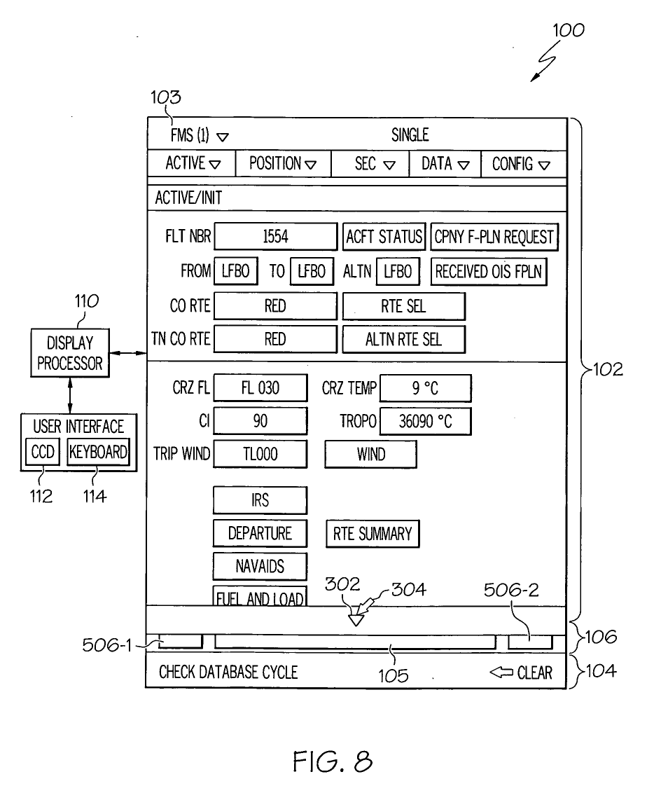

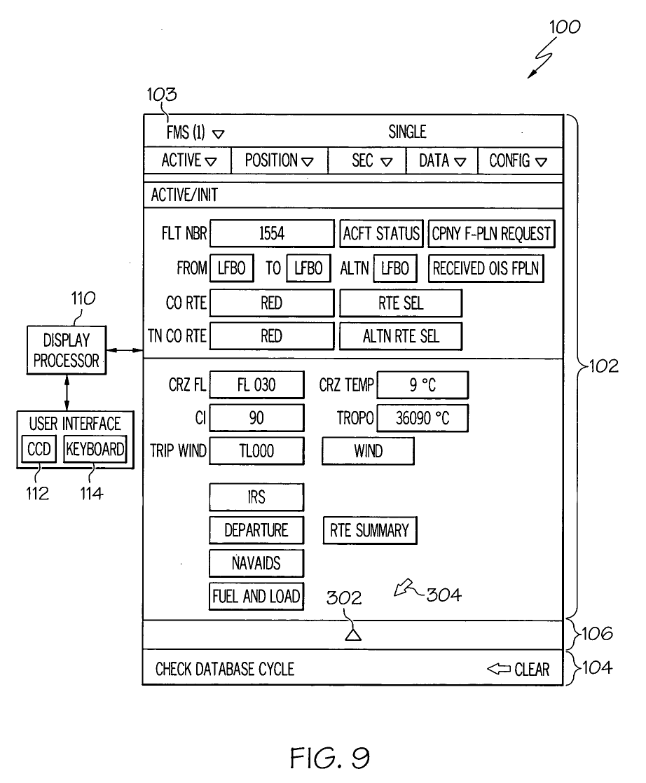

Returning now to the description, it is noted that information 105 continues to be displayed in the enhanced information display area 106, and can be selectively scrolled through using the information scroll icons 506, as long as the cursor icon 304 remains within the enhanced information display area 106, or at least within a predetermined region within the enhanced information display area 106. If the cursor icon 304 is moved outside of the enhanced information display area 106 (or outside of the predetermined region within the enhanced information display area 106), then a predetermined time period thereafter the processor 110 will command the display device 100 to “hide,” or otherwise no longer display, the information 105 in the enhanced information display area 106. It will be appreciated that the processor 110 will also, or alternatively, command the display device 100 to “hide,” or otherwise no longer display, the information 105 if a user re-selects the selection icon 302. Although the “hiding” of the information 105 may be implemented in accordance with any one of numerous techniques, in the depicted embodiment, and as FIGS. 8 and 9 depict, the display processor 110 commands the display device 100 to cease displaying the information 105 and gradually decrease the vertical size of the enhanced information display area 106.

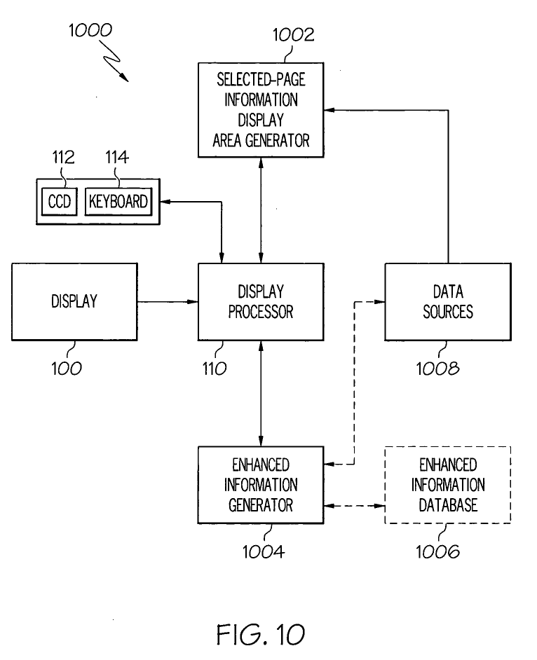

A display system 1000 that may include the display device 100 described above is depicted in FIG. 10 and, for completeness, will now be described. The depicted system 1000 includes the display device 100, the display processor 110, a selected-page information display area generator 1002, and an enhanced information generator 1004. Before proceeding further with the description of the display system 1000, it is noted that although the display processor 110, the selected-page information display area generator 1002, and the enhanced information generator 1004 are depicted in FIG. 10 as separate functional blocks, two or all of these functional blocks could be implemented in a single processing device, or one or more could be implemented using separate devices.

Returning now to the system description, the display processor 110 receives various data and, in response, generates and supplies display commands to the display device 100. It will be appreciated that the display processor 110 may be implemented using any one of numerous processors capable of interfacing with, and supplying display commands to, a display device 100 to display an image thereon. The display device 100, as note previously, is responsive to the display commands to display various images on the display device 100. In the depicted embodiment, the display processor 110 receives data from various user interfaces, including the previously described cursor control device 112 and keyboard 114. The display processor 110 also receives data from the selected-page information display area generator 1002, and the enhanced information generator 1004, both of which will now be described in more detail.

The selected-page information display area generator 1002 receives data from various data sources 1008. The data sources 1008, and the data supplied from the data sources 1008, may vary but, at least in an avionics implementation, preferably includes such data as aircraft speed, aircraft heading, aircraft position, and various engine operational data, just to name a few. The selected-page information display area generator 1002 correlates these data to the display pages 103 that may be selectively displayed in the selected-page information display area 102. The display processor 110, in response to input from one or both of the user interfaces 112, 114, selectively retrieves these correlated data from the selected-page information display area generator 1002 and supplies the display commands to the display device 100 that cause a selected display page 103 (and its correlated data) to be displayed in the selected-page information display area 102.

The enhanced information generator 1004 determines the information 105 to be displayed in the enhanced information display area 106, and supplies data representative of the information 105 to the display processor 110. In the depicted embodiment, the information 105 that is, or may be, displayed in enhanced information display area 106 depends, at least in part, on the display page 103 currently being displayed in the selected-page information display area 102. Although this may be implemented using any one of numerous techniques, in one embodiment the information 105 that may be displayed in the enhanced information display area 106 is pre-associated with each of the selectable display pages 103. In such an embodiment, the system 1000 may included an enhanced information database 1006, which is depicted in phantom in FIG. 10, to store the associations between each selectable display page 103 with predetermined information that can be displayed in the enhanced information display area 106. The enhanced information database 1006 can, in some embodiments, be configured to provide different associations of predetermined information with display pages 103 for different applications. The configurability of the enhanced information database 1006 allows different airlines to select the information 105 it wants displayed in the enhanced information display area 106.

It will be appreciated that in some embodiments, the system 1000 may not include the enhanced information display database 1006. In such embodiments, the enhanced information display generator 1004 and/or the display processor 110 may determine, in real-time, the information 105 that may be displayed in the enhanced information display area 106. Moreover, whether or not the system 1000 includes the enhanced information database 1006, the enhanced information display generator 1004 may also be configured to automatically display the enhanced information display area 106 and information 105 upon the occurrence of one or more events or conditions. For example, the enhanced information display generator 1004 may be configured to automatically display the enhanced information display area 106 and alert or warning information 105. As another example, when the system 1000 is implemented in an avionics embodiment, specific information 105 may be automatically displayed in the enhanced information display area 106 when the aircraft is in a pre-flight mode, a take-off, an airport approach mode, a landing mode, or the like. In such embodiments, the enhanced information generator 1006 may also receive data from one or more of the various data sources 1008.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

What is claimed is:

1. A display system, comprising:
a display device having a display region divided into a plurality of display areas, the display areas including at least a selected-page information display area and an enhanced information display area; and
a display processor coupled to the display device and operable to supply display commands thereto that cause the display device to (i) display one of a plurality of selectable display pages in the selected-page information display area and (ii) selectively display information in the enhanced information display area,
wherein the information displayed in the enhanced information display area is not displayed in the display page being displayed in the selected-page information display area.

2. The system of claim 1, wherein the processor is further operable to supply display commands that cause the display device to automatically cease displaying at least the information in the enhanced information display area.

3. The system of claim 2, wherein:
the enhanced information display area occupies a first predetermined area of the display region when the information is displayed therein, and a second predetermined area when the information is not displayed therein; and
the first predetermined area is greater than the second predetermined area.

4. The system of claim 2, wherein the processor is operable to:
determine occurrence of a predetermined event; and
to supply the display commands that cause the display device to cease displaying at least the information in the enhanced information display area a predetermined time period after the predetermined event occurs.

5. The system of claim 1, further comprising:
a user interface configured to receive user input and, upon receipt thereof, to supply user interface signals,
wherein the display processor is coupled to receive the selection signals from the user interface and is operable to supply the commands that cause the display device to display the information in the enhanced information display area in response to one or more of the user interface signals.

6. The system of claim 4, wherein the processor is further operable to:
supply commands that cause the display device to display a selection icon and a movable cursor in the display region;
move the cursor in the display region in response to one or more of the user interface signals; and
supply the commands that cause the display device to display the information in the enhanced information display area upon movement of the cursor at least partially onto the selection icon and in response to one or more of the user interface signals.

7. The system of claim 6, wherein the processor is further operable to supply display commands that cause the display device to cease displaying at least the information in the enhanced information display area upon movement of the cursor at least partially onto the selection icon and in response to one or more of the user interface signals.

8. The system of claim 6, wherein the processor is further operable to supply the display commands that cause the display device to cease displaying at least the information in the enhanced information display area if no user interface signals are supplied thereto for predetermined time period.

9. The system of claim 6, wherein the selection icon is displayed in the display region at least proximate where the enhanced information display area is displayed.

10. The system of claim 1, wherein the processor is further operable to:
determine an occurrence of one or more events; and
upon the occurrence of one or more of the events, to supply the display commands that cause the display device to display information in the enhanced information display area, the information being related to the one or more events.

11. The system of claim 1, further comprising:
an enhanced information generator in operable communication with the display processor, the enhanced information generator operable to (i) determine the information to be displayed in the enhanced information display area and (ii) supply data representative thereof to the display processor.

12. The system of claim 11, further comprising:
an enhanced information database in operable communication with the enhanced information generator, the enhanced information database having association data stored therein that are representative of associations of each selectable display page with predetermined information that can be displayed in the enhanced information display area.

13. The system of claim 12, wherein the enhanced information generator determines the information to be displayed in the enhanced information generator based at least in part on the association data.

14. The system of claim 1, further comprising:
a selected-page information display area generator in operable communication with the display processor, the selected-page information display area generator configured to receive data from one or more data sources and operable to correlate these data to the selectable display pages.

15. The system of claim 14, further comprising:
a plurality of data sources in operable communication with, and operable to supply data to, the selected-page information display area generator.

16. The system of claim 15, wherein the data supplied from the data sources include aircraft-related data.

17. A method of displaying enhanced information on a display device having at least a display region, the method comprising:
displaying a display page selected from a set of selectable display pages in a selected-page information display area in the display region;
determining whether the enhanced information is displayed in the display page currently being displayed in the selected-page information display area; and
displaying the enhanced information in an enhanced information display area of the display region, only if it is determined that the enhanced information is not displayed in the display page currently being displayed in the selected-page information display area.

18. The method of claim 17, further comprising:
displaying a selection icon at least proximate the enhanced information display area, the selection icon being selectable by a user;
determining if the selection icon has been selected; and
displaying the enhanced information if the selection icon has been selected.

19. The method of claim 17, further comprising:
automatically ceasing to display at least the enhanced information in the enhanced information display area if a predetermined event occurs.

20. The method of claim 19, further comprising:
automatically ceasing to display at least the enhanced information in the enhanced information display area a predetermined time period after the predetermined event occurs.
